(19) United States
(12) Patent Application Publication
(10) Pub. No.: US 2015/0096860 A1
(43) Pub. Date: Apr. 9, 2015

(54) ONE-WAY MECHANICAL CLUTCH SYSTEM AND ALTERNATOR COMPRISING SUCH A SYSTEM

(71) Applicants: Ludovic Fenayon, Montbazon (FR); Eve Goujon, Wurzburg (FR); Torbjorn Hedman, St Cyr sur Loire (FR); Romuald Lescorail, Saint Cyr sur Loire (FR)

(72) Inventors: Ludovic Fenayon, Montbazon (FR); Eve Goujon, Wurzburg (FR); Torbjorn Hedman, St Cyr sur Loire (FR); Romuald Lescorail, Saint Cyr sur Loire (FR)

(73) Assignee: Aktiebolaget SKF, Goteborg (SE)

(21) Appl. No.: 14/507,162

(22) Filed: Oct. 6, 2014

(30) Foreign Application Priority Data
Oct. 4, 2013 (FR) 1359640

(51) Int. Cl. F16D 41/063; F02B 63/04

(52) U.S. Cl. CPC F16D 41/063; F02B 63/042
USPC 192/45.1

(57) ABSTRACT

The invention relates to a one-way clutch mechanical system, in particular a pulley-assembly for a motor vehicle alternator. The one-way clutch mechanical system includes an inner element and an outer element, which are movable relative to one another in rotation around a central axis (X1) and delimits an annular housing between them. The system further includes a one-way clutch device positioned in the annular housing, a member for damping a relative rotational movement between the inner and outer elements and for transmitting torque to the one-way clutch device, which is also positioned in that annular housing. The damping and torque transmission member is axially offset relative to the one-way clutch device, along the central axis (X1).

### FIELD OF THE INVENTION

The present invention relates to a mechanical system with a one-way clutch, such as a pulley-assembly for a motor vehicle alternator. The invention also relates to an alternator comprising such a system configured as a one-way clutch pulley-assembly.

### BACKGROUND OF THE INVENTION

In the field of driving motor vehicle alternators, it is known to use a pulley-assembly equipped with a free wheel forming a one-way clutch device. Such a pulley-assembly makes it possible to transmit a torque between a belt that attacks a crown positioned on the outside of that assembly and an inner hub secured in rotation with the shaft of the alternator. The crown of such an assembly undergoes variations in speed and torque during use, in particular due to the acyclic nature of the engine. To smooth the speed and torque variations exerted on the pulley, it is known to use a one-way clutch (OWC) device, also called a free wheel, between the pulley and the hub. This one-way clutch device transmits a torque from the crown of the pulley-assembly to the hub, but does not transmit torque when the hub rotates faster than the outer crown.

Such a pulley-assembly is sometimes called an “over-running alternator decoupler” (OAD).

Such a decoupler is for example known from US-A-2011/065537 and comprises a ball bearing associated with a free wheel around which a torsion spring is positioned that is engaged, by its ends, with a part secured to the outer crown of the device and with a part engaged with the free wheel. This equipment is relatively complex and comprises a large number of parts. The fact that the spring surrounds the free wheel increases the radial bulk of that decoupler, which may prove prohibitive when the latter is used within an internal combustion engine where space is limited. While the outer diameter of the outer crown is fixed, the parts positioned inside the latter must have a radial dimension smaller than a maximum value, unless the inner volume of the central hub is decreased, which would hinder its assembly on the shaft of the alternator. Under these conditions, the radial space allotted to the subassembly formed by the torsion spring and the free wheel and the associated parts requires that those parts be miniaturized, to the point that the free wheel necessarily becomes difficult to incorporate into pivoting cams. In this respect, the free wheel used in US-A-2011/065537 is of a special type, without a pivoting cam. Furthermore, the torque transmitted from the outer crown to the free wheel via the torsion spring goes through two semi-rigid stamped parts that may deform with wear, which decreases the reliability of that material.

Comparable drawbacks arise in the one-way clutch mechanical systems used in other fields.

### SUMMARY OF THE INVENTION

The invention aims more particularly to resolve these drawbacks by proposing a new one-way clutch mechanical system whereof the radial bulk is better controlled, that is less complex and that is more reliable than the known equipment.

To that end, the invention relates to a one-way clutch mechanical system, in particular a pulley-assembly for a motor vehicle alternator, that includes an inner element and an outer element that are movable relative to one another in rotation around a central axis and delimiting an annular housing between them. The system also comprises a one-way clutch device positioned in the annular housing, as well as a damping and torque transmission member for damping a relative rotational movement between the inner and outer elements and for transmitting torque to the one-way clutch device, which is also positioned in that annular housing. According to the invention, the damping and torque transmission member is axially offset relative to the one-way clutch device, along the central axis of rotation of the inner and outer elements relative to one another.

Owing to the invention, the radial thickness of the damping and torque transmission member is not limited by the radial thickness of the one-way clutch device, and vice versa, such that each of those components can have a mechanical strength in accordance with its purpose. Furthermore, it is not necessary to design complex stamped parts to interact with the damping and torque transmission member.

According to advantageous but optional aspects of the invention, such a mechanical system incorporates one or more of the following features, in any technically allowable combination:
This system further includes a bearing with rolling elements that is also axially offset relative to the one-way clutch device, while the damping and torque transmission member and the bearing with rolling elements are positioned, along the central axis, on either side of the one-way clutch device.
The damping and torque transmission member is adjacent to a ring that axially delimits the annular housing, along the central axis.
The ring is provided with at least one raised portion for activating the damping and torque transmission member.
The damping and torque transmission member is mounted in the annular space.
The damping and torque transmission member is a brake spring.
The damping and torque transmission member is a ring made from an elastically deformable synthetic material.
The one-way clutch device has a sleeve mounted on the first element, among the inner and outer elements, with the possibility of rotation around the central axis against the action of the damping and torque transmission member, while that sleeve is provided with at least one raised portion for activating that member.
The ring and the sleeve are positioned, along the central axis, on either side of the damping and torque transmission member.

The invention also relates to an alternator comprising a mechanical system as described above configured as a pulley-assembly with a one-way clutch.

### BRIEF DESCRIPTION OF THE DRAWINGS

The invention will be better understood and other advantages thereof will appear more clearly in light of the following description of five embodiments of a one-way clutch mechanical system according to its principle, provided solely as an example and done in reference to the appended drawings, in which :

FIG. 1 is an axial cross-sectional block diagram of a system according to a first embodiment of the invention;

FIG. 2 is a cross-sectional view along line II-II in FIG. 1;

FIG. 3 is an exploded perspective view, with a partial cutaway, of the system of FIG. 1;

FIG. 4 is an enlarged perspective view with a partial cutaway of the system of FIG. 1 in the mounted configuration;

FIGS. 5 and 6 are views similar to FIGS. 1 and 3, respectively, for a system according to a second embodiment of the invention;

FIGS. 7 and 8 are views similar to FIGS. 1 and 3, respectively, for a system according to a third embodiment of the invention;

FIGS. 9 and 10 are views similar to FIGS. 1 and 3, respectively, for a system according to a fourth embodiment of the invention; and

FIGS. 11 and 12 are views similar to FIGS. 1 and 3, respectively, for a system according to a fifth embodiment of the invention, FIG. 12 not, however, including a partial cutaway.

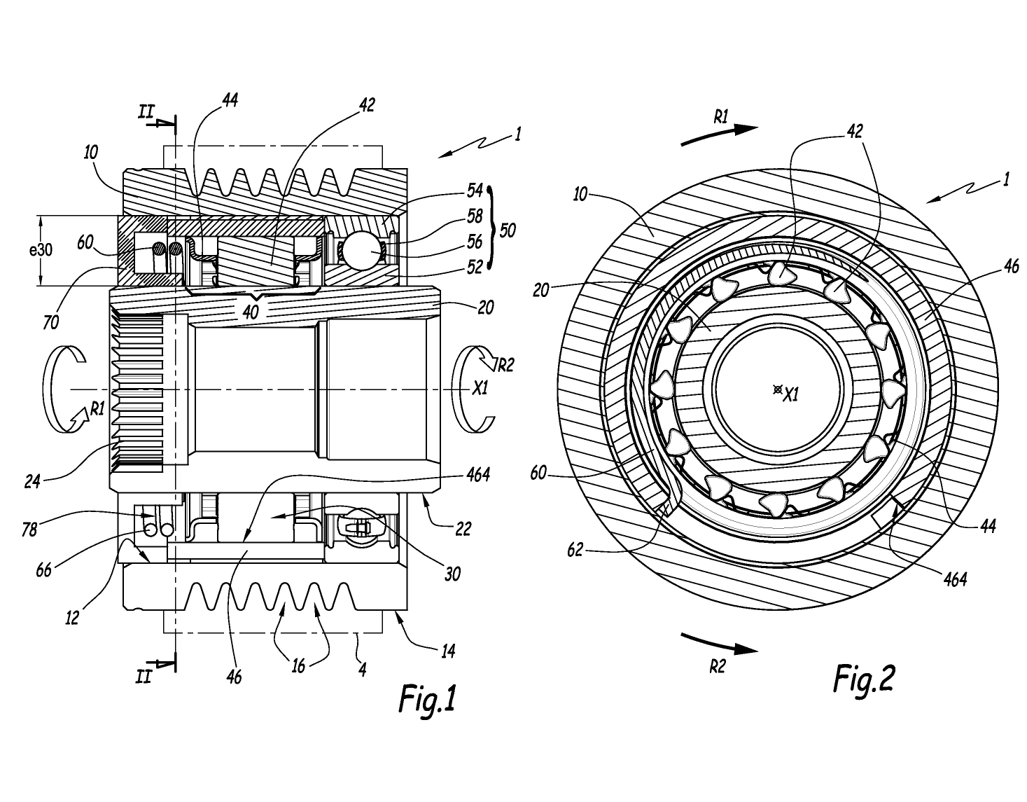

For the clarity of the drawing, crosshatching has been incorporated only into the upper parts of FIGS. 1, 5, 7, 9 and 11.

### DETAILED DESCRIPTION OF THE INVENTION

FIGS. 1 to 4 show a pulley-assembly 1 according to the invention and suitable for equipping a motor vehicle alternator shown in mixed lines by its driveshaft 2, only in FIG. 4, for simplification purposes.

The pulley-assembly 1 is centered on an axis X1 and comprises an outer crown 10 and an inner hub 20 between which an annular housing 30 is defined that is radially delimited between an inner radial surface 12 of the crown 10 and an outer radial surface 22 of the hub 20.

The crown 10 is provided, on its outer radial surface 14, with grooves 16 allowing it to cooperate with a notched belt 4 shown in mixed lines only in FIG. 1, for the clarity of the drawing.

The inner hub 20 is equipped with an inner toothing 24 allowing an effective transmission of a rotational torque around the axis X1 to the shaft 2, which is configured in a corresponding manner and also rotates around the axis X1.

It will be noted that the surfaces 12 and 22 are each cylindrical, with a circular base and rectilinear generatrix. These surfaces are therefore easy to produce, with a particularly attractive cost.

Inside the housing 30, a one-way clutch device or “free wheel” 40, a ball bearing 50, a brake spring 60 and a spacer ring 70 are positioned.

The crown 10 and the hub 20 are rotatable relative to one another around the axis X1.

The free wheel 40 makes it possible to engage the crown 10 with the hub 20 in rotation in a first direction of rotation R1 around the central axis X1, and conversely, to disengage the crown 10 relative to the hub 20 in a second direction of rotation R2 opposite the first direction of rotation R1. This free wheel or one-way clutch device 40 may be in accordance with the technical teaching of WO-A-2011/079963. It comprises several cams 42 guided by a cage 44 to bear, by suitable geometric surfaces, against the outer radial surface 22 of the hub 20 and against an inner radial surface 462 of the sleeve 46 that is part of the free wheel 40 and is mounted radially inside the crown 10, respectively, with a possibility of rotation relative to that crown around the axis X1.

The rolling bearing 50 comprises an inner ring 52, an outer ring 54, a row of balls 56 and a cage 58 for keeping the balls in position inside a rolling cage defined between the rings 52 and 54. The rolling bearing 50 allows the relative rotation between the elements 10 and 20 around the axis X1.

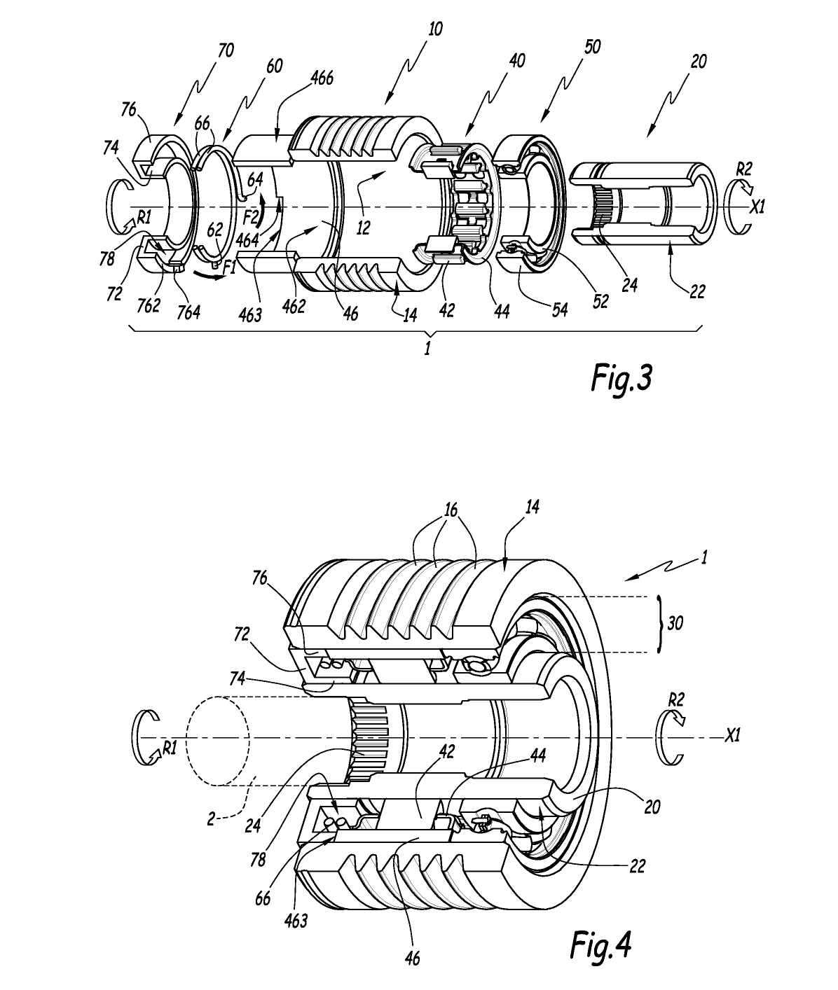

The spring 60 is a brake spring formed by a rod of elastically deformable material, such as steel, with turns whereof the diameter varies based on the direction of a force bringing two ends 62 and 64 of that rod that are curved radially toward the outside of the spring 60, as shown in FIG. 3, closer together or further apart.

The ring 70 is secured in rotation, for example glued, with the inner radial surface 12 of the crown 10. The ring 70 axially limits the space 30 on the side opposite the rolling bearing 50, whereas the rolling bearing 50 axially limits the space 30 on the side opposite the ring 70.

The ring 70 can be made from a synthetic material or metal. In radial cross-section relative to the axis X1, it is globally U-shaped with an annular bottom wall 72, planar and perpendicular to the axis X1, as well as two side walls, inner 74 and outer 76, respectively, that form the branches of the U-shaped cross-section of the ring 70 and that are each cylindrical and centered on the axis X1. The branches 74 and 76 have different axial widths, measured parallel to the axis X1. Alternatively, these lengths can be equal.

The walls 74 and 76 define an inner volume 78 of the ring 70 between them in which the turns 66 of the spring 60 are partially received. In the example, the wall 76 is glued against the surface 12 of the crown 10, while the wall 74 slidingly bears against the surface 22 of the hub 20.

The edge 762 of the wall 76 opposite the bottom 72 is equipped with a tooth 764 protruding relative to that edge in a direction parallel to the axis X1. That tooth 764 is intended to interact with the end 62 of the spring 60.

Furthermore, the edge 463 of the sleeve 46 turned toward the ring 70 and the spring 60 is provided with a shoulder 464 designed to interact with the end 64 of the brake spring 60.

The operation is as follows: when the crown 10 is driven by the belt 4 around the axis X1 in the direction of rotation R1, the belt 10 drives the ring 70 whereof the tooth 764 exerts, on the end 62 of the spring 60, a force in the direction of arrow F1 in FIG. 3. The continuation of the rotational movement R1 results first in rotating the spring 60 around the wall 74, which brings the end 64 of the spring 60 into contact with the shoulder 464. The movement of the end 64 of the spring 60 toward the shoulder 644 is shown by arrow F2 in FIG. 3. The resistance opposed by the sleeve 46 against the rotation in the direction R1 results in bringing the ends 62 and 64 closer to each other, which results in radially tightening the turns of the spring 60 around the wall 74. This results in securing the elements 60 and 70 in rotation around the axis X1.

The sleeve 46 then rotates in the direction of rotation R1 and exerts, on the cams 42, across from which it is positioned axially along the axis X1, a force that causes them to pivot in a configuration where those cams block each other between the surfaces 462 and 22, to the point that they transmit the torque from the sleeve 46 to the inner hub 20. The inner hub 20 then rotates in the direction of rotation R1 while being supported, on one side of the device 40 along the axis X1, by the rolling ball bearing 50 and, on the other side, by the spacer ring 70 that forms a plain bearing with the hub 20, at the interface between the wall 74 and the surface 22.

On the contrary, if the outer crown 10 rotates more slowly in the direction R1 than the inner hub 20, i.e., if the elements 10 and 20 tend to rotate relative to one another in the direction of rotation R2, the free wheel 40 prevents the transmission of torque between those elements, such that the inner hub 20 can rotate more quickly around the axis X1 in the direction of rotation R1 than the other crown 10. In that case, the spring 60 is not radially compressed around the wall 74, due to its interaction with the raised portions 764 and 464, such that there is no securing in rotation between the elements 60 and 70.

Thus, the spring 60 makes it possible on the one hand to transmit the torque, between the crown 10 and the free wheel 40, and on the other hand, to damp the jolts during acceleration of the outer crown 10 relative to the inner hub 20 in the direction of rotation R1 because the rotational movement is only transmitted after the end 62 and 64 of that spring interact simultaneously with the raised portions 764 and 464 to drive the sleeve 46, i.e., after the spring 60 has been elastically deformed. The spring 60 therefore makes it possible both to damp the relative rotational movement between the elements 10 and 20 upon startup and to transmit the torque in the direction of rotation R1 of the outer crown 10 to the device 40.

Since the spring 60 and the ring 70 are axially offset relative to the device 40, the entire radial thickness e₃₀ of the housing 30 is available for the clutch device 40, which makes it possible to use cams 42, a cage 44 [and] a sleeve 46 that are all robust. Likewise, the entire radial thickness e₃₀ of the housing 30 is available to house the spacer ring 70, which can also be robust, which is important because it participates in maintaining the radial separation between the elements 10 and 20, around the axis X1, while forming a radial spacer that acts as a complement to the rolling ball bearing 50.

Furthermore, since the spring 60 and the ring 70 are positioned on one side of the device 40 along the axis X1, while the rolling ball bearing 50 is positioned on the other side, the forces exerted on the device 40 are globally balanced, which contributes to the proper lifetime of the pulley-assembly 1.

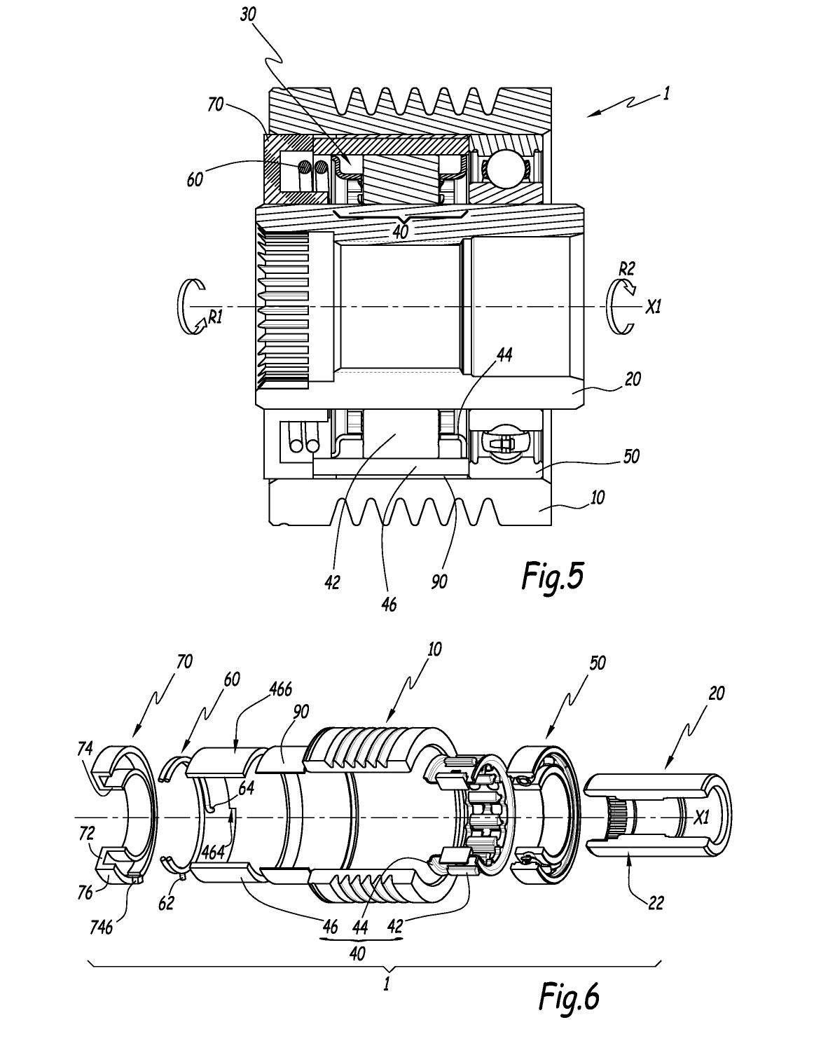

In the second to fifth embodiments of the invention shown in FIGS. 5 and following, elements similar to those of the first embodiment bear the same references. Hereinafter, we primarily describe what differs between these embodiments and the first.

In the second embodiment of FIGS. 5 and 6, a trim 90 made from polytetrafluoroethylene (PTFE) is radially inserted between the outer radial surface 466 of the sleeve 46 and the inner radial surface 12 of the crown 10. This trim 90 serves to damp the transitional phase upon torque transfer, i.e., to brake the relative rotation between the outer crown 10 and the sleeve 46, while the spring 60 is not completely operational to transmit the torque between the elements 70 and 46. The trim 90 increases the friction coefficient between the parts 10 and 46, which prevents the oscillations of the parts 10 and 46 relative to one another, in rotation around the axis X1, when the outer crown 10 rotates more quickly than the sleeve 46 in the direction of rotation R1. In other words, the trim 90 introduces a sort of hysteresis into the relative movement of the parts 10 and 46 with respect to one another, for dynamic stabilization purposes and in order to avoid oscillations, as mentioned above.

For the rest, this embodiment works like the first.

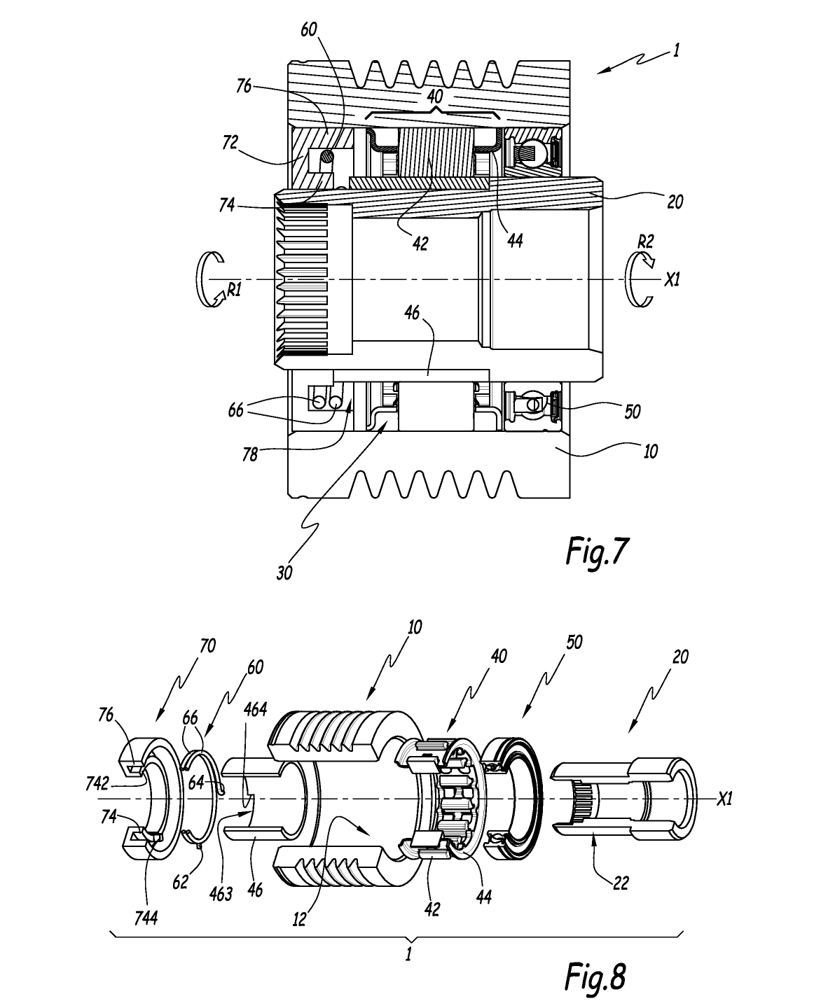

In the third embodiment shown in FIGS. 7 and 8, the ring 70 is secured by its inner wall 74 to the inner sleeve 20. The ring 70 may be glued, forcibly mounted or crimped on the inner sleeve 20. In that case, the edge 742 of the wall 74 opposite the bottom 72 is equipped with a tooth 744 designed to interact with one end 62 of the spring 60 that is outwardly curved, i.e., opposite the axis X1, relative to the turns 66 of that spring. The edge 463 of the sleeve 46 oriented toward the spring 60 is, as in the first embodiment, equipped with a shoulder 464 designed to interact with the second end 64 of the spring 60.

In the event the outer crown 10 tends to rotate more quickly than the inner sleeve 20 in the direction of rotation R1, the inner radial surface 12 of the crown 10 acts directly on the cams 42 of the device 40 to cause those cans to switch into a torque transmitting configuration in which the cams 42 drive the sleeve 46 in the same direction, in rotation around the axis X1. That sleeve then, by its raised portion 464, drives the end 64 of the sleeve 60, which results in radially tightening the turns 66 of the spring 60 and rotating the end 62 in the same direction, which pushes on the tooth 744, which drives the ring 70 in the same direction. Since the ring 70 is secured in rotation with the inner sleeve 20, it then rotates that sleeve in the same direction of rotation R1. The contraction of the turns 66 of the spring 60 results in the rotational securing of the spring 60 and the wall 76 of the ring 70.

In case of rotation in the opposite direction, the free wheel 40 does not transmit torque, as in the first embodiment.

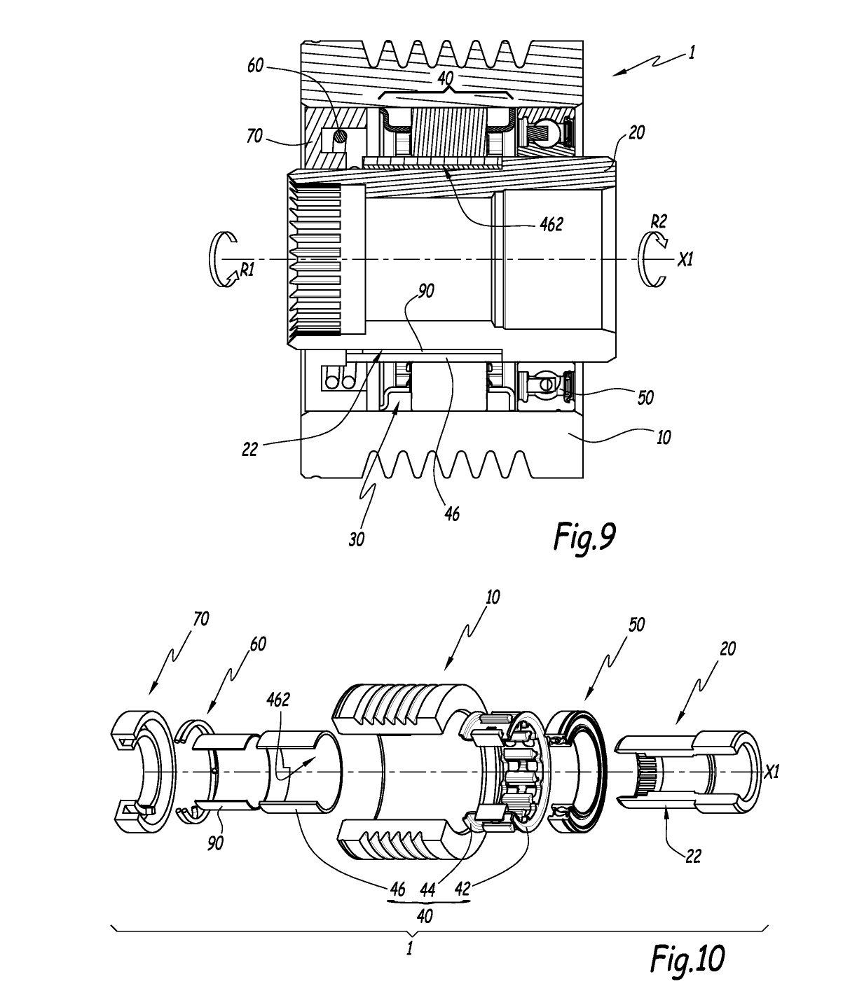

In the fourth embodiment shown in FIGS. 9 and 10, a trim 90 is used as in the second embodiment, while the general architecture of the pulley-assembly 1 is close to that of the third embodiment. The trim 10 is radially inserted between the inner radial surface 462 of the sleeve 46 and the outer radial surface 22 of the hub 20.

In the first four embodiments described above, the spring 60 is not necessarily of the torsion spring type with circular turns, like that shown in the figures. It may have other turn shapes. It may for example be a “clock spring”.

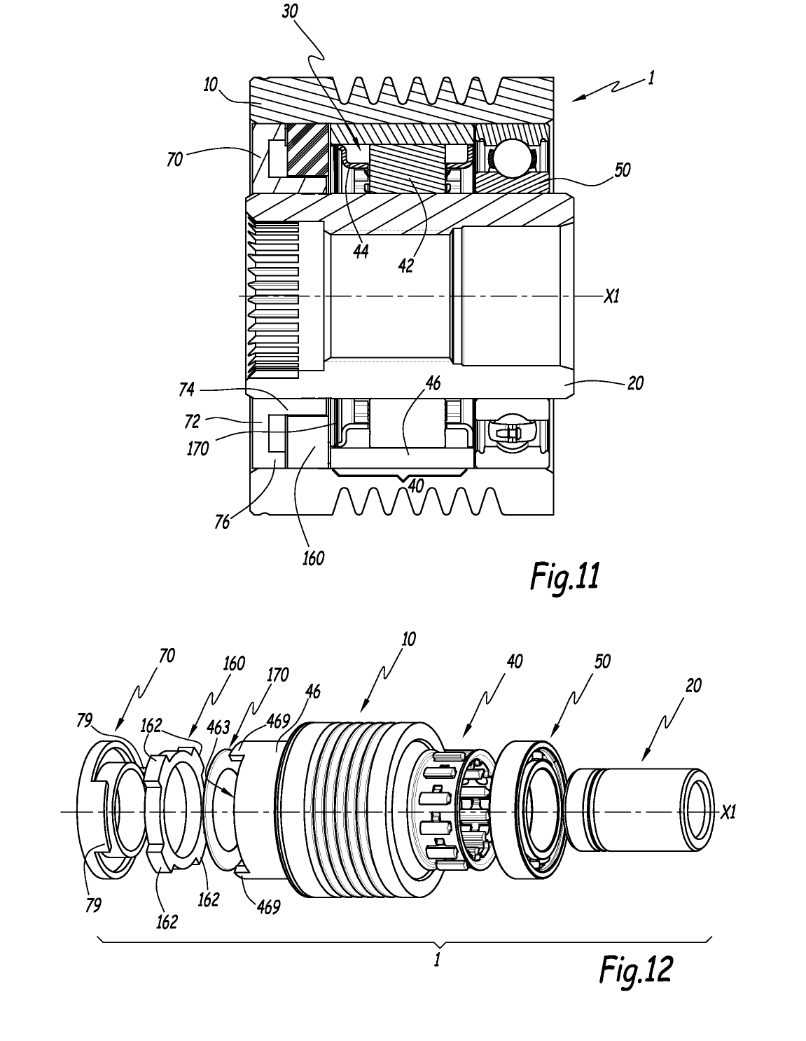

In the fifth embodiment shown in FIGS. 11 and 12, an elastomeric ring 160 is used as a member for damping the relative rotation between the elements 10 and 20 and as a torque transmission member from the crown to the free wheel 40. That ring 160 is provided with four spurs 162 that extend radially outward relative to the ring 160, on four angular sectors regularly distributed around its central axis combined with the axis X1 during use. The spacer ring 70 is equipped with two teeth 79 that engage between two adjacent spurs 162 of the ring 160. On another side, the sleeve 46 is equipped with two other teeth 469 protruding relative to its edge 463 turned toward the ring 160 and designed to engage between two spurs 162 of the ring 160, in the spaces left free by the teeth 79.

A reinforcing ring 170 is inserted between the free wheel 40 and the ring 160, with an outer diameter smaller than the inner diameter of the teeth 469, such that it limits the deformations of the ring 160 in an axial direction oriented toward the device 40, without hindering the engagement between the elements 46 and 160.

During the transmission of torque between the elements 70 and 46, which occurs in a manner comparable to that explained for the first body, the spurs 162 of the ring 160 work by shearing. The elastic nature of the material used for the ring 160 allows it to damp the relative rotation between the elements 70 and 46, i.e., between the elements 10 and 20. The relative rigidity of that ring also allows it to transmit the torque effectively between those elements 70 and 46.

Alternatively, in place of an elastomer, another less deformable synthetic material may be used to form the ring 160.

Alternatively, the rolling bearing 50 may be a rolling bearing with rolling bodies of a type different from a rolling ball bearing, for example a rolling bearing with rollers or needles.

In all of the embodiments, the ring 70 forms a plain bearing, either with the inner hub 20, or with the outer crown 10.

In all embodiments, the fact that the torque transmission member 60 or 160 is axially offset relative to the one way clutch 40, along central axis X1, implies that along this axis, items 60 and 40, or items 160 and 40, do not overlap.

The invention is not limited to the field of pulley-assemblies for alternators.

The embodiments and alternatives discussed above may be combined to create new embodiments.

1. A one-way clutch mechanical system, in particular a pulley-assembly for a motor vehicle alternator, the system comprising:
an inner element and an outer element that are movable relative to one another in rotation around a central axis (X1) and delimiting an annular housing between them,
a one-way clutch device positioned in the annular housing,
a damping and torque transmission member for damping a relative rotational movement between the inner and outer elements and for transmitting torque to the one-way clutch device, which is also positioned in that annular housing, and wherein
the damping and torque transmission member is axially offset relative to the one-way clutch device, along the central axis (X1).

2. The one-way clutch mechanical system according to claim 1, further comprising a bearing with rolling elements axially offset relative to the one-way clutch device and the damping and torque transmission member and the bearing with rolling elements are positioned, along the central axis (X1), on either side of the one-way clutch device.

3. The one-way clutch mechanical system according to claim 1, wherein the damping and torque transmission member is adjacent to a ring that axially delimits the annular housing (X1), along the central axis (X1).

4. The one-way clutch mechanical system according to claim 3, wherein the ring is provided with at least one raised portion for activating the damping and torque transmission member.

5. The one-way clutch mechanical system according to claim 1, wherein the damping and torque transmission member is mounted in the annular space.

6. The one-way clutch mechanical system according to claim 1, wherein the damping and torque transmission member is a brake spring.

7. The one-way clutch mechanical system according to claim 1, wherein the damping and torque transmission member is a ring made from an elastically deformable synthetic material.

8. The one-way clutch mechanical system according to claim 3, wherein the one-way clutch device includes a sleeve mounted on a first element, among the inner and outer elements, with the possibility of rotation around the central axis (X1) against the action of the damping and torque transmission member, and the sleeve is provided with at least one raised portion for activating that member.

9. The one-way clutch mechanical system according to claim 8, wherein the ring and the sleeve are positioned, along the central axis (X1), on either side of the damping and torque transmission member.

10. An alternator, comprising:
a mechanical system configured as a pulley-assembly with a one-way clutch and having;
an inner element and an outer element that are movable relative to one another in rotation around a central axis (X1) and delimiting an annular housing between them,
a one-way clutch device positioned in the annular housing,
a damping and torque transmission member for damping a relative rotational movement between the inner and outer elements and for transmitting torque to the one-way clutch device, which is also positioned in that annular housing, wherein
the damping and torque transmission member is axially offset relative to the one-way clutch device, along the central axis (X1).
